(19) United States
(12) Patent Application Publication
(10) Pub. No.: US 2012/0098163 A1
(43) Pub. Date: Apr. 26, 2012

(54) CONTINUOUS PROCESS ASSISTED BY ULTRASOUND OF VARIABLE FREQUENCY AND AMPLITUDE FOR THE PREPARATION OF NANOCOMPOSITES BASED ON POLYMERS AND NANOPARTICLES

(75) Inventors: Carlos Alberto Ávila-Orta, Coahuila (MX); Juan Gullermo Martinez Colunga, Coahuila (MX); Dario Bueno Baquéz, Coahuila (MX); Cristina Elizabeth Raudry López, Coahuila (MX); Víctor Javier Cruz Delgado, Coahuila (MX); Pablo González Morones, Coahuila (MX); Janett Anaid Valdez Garza, Coahuila (MX); Maria Elina Esparza Juárez, Coahuila (MX); Carlos José Espinoza González, Coahuila (MX); José Alberto Rodríguez González, Coahuila (MX)

(73) Assignees: CENTRO DE INVESTIGACION EN QUIMICA APLICADAD, Saltillo, Coahuila (MX); NANOSOLUCIONES S.A.DE C.V., Metepec (MX)

(21) Appl. No.: 13/258,930

(22) PCT Filed: Apr. 7, 2010
(86) PCT No.: PCT/MX2010/000032

§ 371 Date: Dec. 30, 2011

(30) Foreign Application Priority Data
Apr. 8, 2009 (MX) MX/A/2009/003842

(51) Int. Cl. B29B 7/58

(52) U.S. Cl. 264/444

(57) ABSTRACT

The invention relates to a continuous mixing/extrusion method, assisted by ultrasound waves with a variable amplitude and frequency, for the preparation of nanocompounds based on polymers, preferably thermoplastics and nanoparticles, at a concentration of up to 60 wt.-% of the total weight of the polymer/nanoparticle mixture. According to the invention, the polymer/nanoparticle mixture is subjected in the molten state to a discrete and continuous sweep with a variable amplitude and frequency, of between 15 kHz and 50 kHz.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention describes a continuous mixing/extrusion process, assisted by ultrasonic waves with varying frequency and amplitude, for the preparation of nanocomposites by means of nanoparticle dispersion within polymer matrices. Their application in the fields of biomedicine, optics, electronics, electromagnetism, semiconductors, and materials resistant to mechanical and thermal degradation is also described.

2. Description of Related Art Including Information Disclosed Under 37 CFR 1.97 and 37 CFR 1.98.

Nanotechnology comprises various fields of science and technology that study and/or manipulate substances, materials, and devices in a controlled manner at a nanometric scale (1 nm=10^{˜}9 m). In particular, the incorporation of nanoparticles within polymer matrices is a current field of interest in materials engineering because of its uses in various applications. They include, for example, applications within the automotive, biomedical, optics, electronics, and semiconducting material industries. In fact, the availability of new strategies for the production of nanocomposites, as well as tools for their characterization and manipulation, has led to an explosive rise in this area.

In principle, nanoparticles are nano-objects which have at least one dimension within the nanometric scale. Their properties differ significantly from those of their bulk state due to having a greater percentage of their atoms on the surface, as surface atoms are more active than those located in the interior. Their wide range of biomedical, optical, electronic, and electromagnetic properties, as well as their thermal and mechanical degradation resistance, makes them attractive for the preparation of polymers reinforced with homogeneously dispersed nanoparticles—known as polymer nanocomposites—that have improved properties and functional characteristics.

Improvement of these properties can only be obtained with the achievement of a homogeneous dispersion that enables the proper interaction of the nanoparticles with the polymer matrix. Various physical, chemical, and physicochemical methods have been used to achieve the properties previously described. These methods include the chemical modification of nanoparticles in solution or with plasma treatment and their subsequent mixture with a polymer solution, with a polymer molten during extrusion, within in-situ polymerization processes, and during extrusion with chemically modified polymers, among others. The use of solution processes can achieve a high degree of nanoparticle dispersion; however, the use and handling of chemical solvents during the process cause these methods to be environmentally unfriendly. On the other hand, the preparation of nanocomposites using melt mixing requires the use of shear stresses to break up the nanoparticle agglomerates, which presents a technical problem: they can lead to unwanted modifications of the nanoparticle, compromising its structure and thus causing the loss of the desired properties. If the applied shear stresses are low, the breakup of the agglomerates, and thus a homogeneous dispersion of the nanoparticles, will not be achieved. From a current global perspective, situations such as the shortage of petroleum, global warming, etc. create a need for processes that are viable from a technical, economic, and environmentally-friendly perspective, such as the one developed in this invention.

Recently, the use of ultrasonic waves in solvent-free processes such as melt mixing/extrusion have enabled the production of nanocomposites with homogeneously dispersed nanoparticles and concentrations of up to 30% by weight of the nanoparticle-polymer mixture, reducing considerably the effects of the previously described use of high shear forces for the dispersion of nanoparticles. Patents US2006/0148959 and WO2007/145918 describe a continuous process of extrusion mixing for the preparation of polymer nanocomposites assisted by ultrasonic waves. In this process, the material is melted during its advancement along the extrusion chamber by means of single or twin screws. Subsequently, the molten material enters a pressurized zone wherein ultrasonic waves with constant, static, or fixed frequency and amplitude are applied, thus transmitting a certain fixed power to the medium. This is thus considered a static ultrasound system. The ultrasonicated material exits through the end of the equipment and is subsequently cooled and pelletized. Nevertheless, the use of static ultrasonic systems limits the dispersion efficiency, given that the physical properties of the medium-such as the length of the polymeric chains and the size distributions of the nanoparticles and the agglomerates-are heterogeneous and change further when they come into contact with ultrasonic waves. This limits their coupling with the medium and adequate energy transfer, hence presenting an additional technical problem to the one mentioned previously. Therefore, the process under discussion only allows the production of nanocomposites with nanoparticle concentrations of up to 20% and 30% of the total weight of the polymer-nanoparticle mixture in the case of patents WO2007/145918 and US2006/0148959, respectively. In other words, these processes partially resolve the existing technical problem previously described since, in practice, it is desirable to process materials originating from nanocomposites with a high nanoparticle concentration of up to 60% by weight.

From the previous information we derive the existing limitation and hence the motivation behind the current invention: the impact of ultrasonic waves with the polymer matrix changes its local properties, such as viscosity, molecular order, etc. and thus promotes nanoparticle dispersion. However, by changing the properties of the medium, this same frequency—and thus the energy transfer—is no longer efficient at dispersing nanoparticles, making it necessary to apply a higher frequency to increase energy transfer and promote a greater nanoparticle dispersion. In any given moment the situation can repeat itself, which can require another change in frequency and power, and so on.

### BRIEF SUMMARY OF THE INVENTION

As an alternative to the requirements previously described, the present invention describes the use of dynamic systems of ultrasonic waves, which consist of applications of ultrasonic waves of varying frequency and amplitude within a fixed frequency interval, that is, frequency scans. This has the objective of coupling waves with different frequencies to the heterogeneities of the medium, which assists the destruction of agglomerates of varying sizes and yields efficient nanoparticle dispersion.

In addition, the energy transfer to the medium during the application of ultrasonic waves with constant, static, or fixed frequency and amplitude becomes more difficult when the molten polymer undergoes high pressure due to its movement through a pressurized zone and a high nanoparticle content of up to 30% by weight—as described in patent applications US2006/0148959 and WO2007/145918—which has a negative effect on efficient nanoparticle dispersion at concentrations higher than 30% by weight. In great contrast with these previous cases, the present invention—in which the combined effect of the application of ultrasonic waves with variable frequency and amplitude, when the molten polymer becomes depressurized as described, favors energy transfer to the medium but does not limit when the polymer travels from a pressurized zone, or a circulation area or a narrow canal, to a depressurized area, or circulation area or wide canal—enables the production of nanocomposites containing homogeneously dispersed nanoparticles at concentrations much greater than 30%, as well as the concentrations described in US2006/0148959 and WO2007/145918. In practice, it is desirable to process materials starting from nanocomposites with a high nanoparticle concentration of up to 60% by weight.

In summary, the use of continuous melt mixing/extrusion processes assisted by ultrasonic waves with fixed frequency and amplitude for the homogeneous dispersion of nanoparticles within polymer matrices is known in the prior art. Nevertheless, up to now, the use of a continuous melt mixing/extrusion process assisted by ultrasonic waves with variable frequency and amplitude that allows the processing of polymer nanocomposites with a nanoparticle concentration much greater than 30% by weight has not been described. The present invention covers a continuous melt mixing/extrusion process for the preparation of nanocomposites based on polymers and nanoparticles, using ultrasonic waves with variable frequency and amplitude that enables the homogeneous dispersion of nanoparticles, even at concentrations much greater than 30% by weight.

The use of ultrasonic waves with variable frequency and amplitude in a polymer-nanoparticle mixture during a depressurization stage of the melt significantly increases the degree of nanoparticle dispersion even at concentrations much greater than 30% by weight, avoiding the use of high shear stresses by means of a single screw or twin screw extruder during the processes of melting and mixing the material. The latter gives rise to the present invention, which presents a solution to the technical and environmental problems thoroughly described in the prior art.

### BRIEF DESCRIPTION OF THE DRAWINGS

FIG. 1 shows an X-ray diffractogram of the EVA/Cloisite® 6A and EVA/Cloisite® 20A nanocomposites. The peaks corresponding to angles of 3 and 4.5 attest to the high degree of exfoliation reached by the Cloisite®20A nanoclays in the EVA matrix using the process described in this invention.

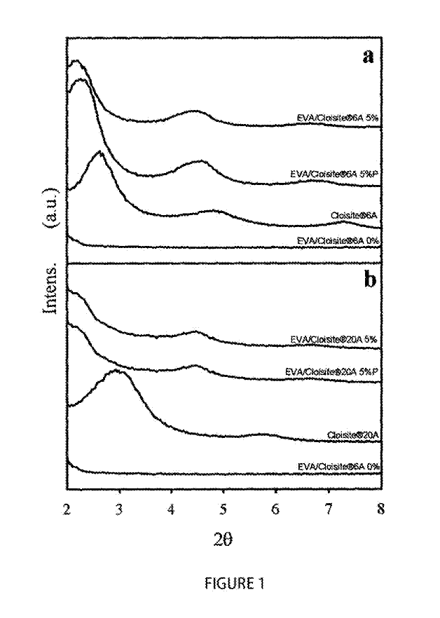

FIG. 2 shows an SEM image of the LLDPE-α-olefin/Ag nanocomposite in which the high degree of dispersion of the silver nanoparticles in the copolymer matrix can also be observed. The use of ultrasonic waves with variable frequency and amplitude guarantees the homogeneous dispersion of nanoparticles that have a wide size distribution.

### DETAILED DESCRIPTION OF THE INVENTION

The present invention refers to a continuous process of melt mixing/extrusion for the preparation of nanocomposites with nanoparticle concentrations in polymer matrices of up to 60% by weight that uses ultrasonic waves with variable frequency and amplitude and enables homogeneous nanoparticle dispersion. The process can comprise a premixing stage of at least one type of polymer and/or copolymer or a mixture thereof and at least one type of nanoparticle, where shear stresses are applied in the melt to obtain a distributed dispersion of the nanoparticle agglomerates within the polymer matrix. The premixture obtained is subjected to a melt mixing/extrusion stage assisted by ultrasonic waves with variable frequency and amplitude, applied using continuous or discrete scans, to obtain a homogeneous nanoparticle dispersion within the polymer matrix. The ultrasonic waves are produced by a wave frequency generator and can be applied in more than one zone during the mixing/extrusion process, as long as they are applied over at least one depressurization zone of the molten material.

In the present invention, the polymers used can be neat and/or recycled resins obtained by any synthesis method and are selected from the group that comprises thermoplastic polymers, in which at least one thermoplastic polymer and/or copolymer is selected for the preparation of the polymer-nanoparticle compound. Examples of these polymers include, but are not limited to, commodity polymers, engineering polymers, elastomers, or a mixture of two or more thereof.

For the purposes of the present invention, commodity polymers and/or copolymers refer to low cost polymeric resins with very large production volumes and includes, without limiting the invention, polyolefins, polyaromatics, poly(vinyl chlorides), or a mixture of two or more thereof. Examples include polyethylenes, polypropylenes, poly(vinyl chloride), and polystyrene, among others.

In the present invention the polyolefin group includes, but is not limited to, polyethylene, polypropylene, and polyisoprene, among others. From the polyethylene and polypropylene group they include, but are not limited to, low density polyethylene (LDPE), high density polyethylene (HDPE), linear low density polyethylene (LLDPE), ultra-high molecular weight polyethylene (UHMWPE), isotactic polypropylene (i-PP), syndiotactic polypropylene (s-PP), atactic polypropylene (a-PP), ethylene-propylene copolymer, α-olefin copolymer, ethylene vinyl acetate (EVA), or a mixture of two or more thereof.

A preferred embodiment of the present invention consists of the use of i-PP, s-PP, a-PP, and mixtures of α-olefin copolymer and LLDPE, and preferably greater use of i-PP.

In the present invention, engineering polymer refers to polymeric resins that have better mechanical and thermal properties than commodity polymers, aside from having a low cost. Examples of these polymers can be, but are not limited to, polyacrylic polyesters, polycarbonates and polyamides, which include poly(ethylene terephthalate); poly(methyl methacrylate); nylon; nylon 6; nylon 6,6; nylon 11; nylon 6,10; and nylon 6,12; among others. An embodiment of the invention is the use of nylon 6.

The term elastomer refers to polymers with a great capacity for elastic deformation upon the application of very small stresses. Examples of these include, but are not limited to, poly(isoprene butadiene), styrene-butadiene-styrene, and ethyl vinyl acetate (EVA) copolymers, among others.

In the present invention, the nanoparticles are selected from a group that comprises organic and/or inorganic nanoparticles and include, but are not limited to, ceramic, metallic, and carbon nanoparticles, among others. Examples of these nanoparticles include, but are not limited to, carbon nanotubes, carbon nanofiber, nanoclays, transition metal nanoparticles, oxide nanoparticles, bimetallic nanoparticles, multi-layered metallic nanoparticles, functionalized nanoparticles, nanoparticles contained in mineral matrices, nanoparticle-containing zeolites, and nanoparticle-containing silica, among others, and mixtures thereof.

In the present invention, the term carbon nanotube refers to a nanotube composed substantially of, or essentially of, carbon. These can be single-walled carbon nanotubes (SWNT), which are composed of a single wall of carbon atoms, and multi-walled carbon nanotubes (MWNT), which are composed of multiple concentric tubes of carbon atoms.

The nanoparticles used in the present invention are preferably SWNT, MWNT, carbon nanofibers (CNFs), graphene, or a mixture of two or more thereof; nanoclays of silica, phyllosilicates, and aluminosilicates that include montmorillonite, kaolinite, kanemite, and hectorite; silver, gold, copper, zinc, titanium, and multi-metallic nanoparticles; and their compounds or mixtures of two or more thereof.

An embodiment of the present invention is the use of MWNT and silver nanoparticles.

The nanoparticles used in this invention can be prepared by various methods not excluding those known in the prior art, including any other method that is capable of synthesizing or producing nanoparticles, either as a primary, secondary, or waste product, even if these are used with or without treatment prior to premixing, such as chemical functionalization via plasma and cleaving of chemical bonds, among others.

In the present invention, the nanoparticle concentration used for preparing the nanocomposite is between 0.01% and 60% of the total weight of the polymer-nanoparticle mixture, preferably in the range of 1% to 40% of the total weight of the polymer-nanoparticle mixture, and even more preferably in the range of 1% to 20% of the total weight of the polymer-nanoparticle mixture. In the present invention, the application of shear forces in the melt state within the premixing stage can be carried out in an internal mixer, single screw extruder, twin screw extruder, extruder without screws, or another process capable of achieving a distributed dispersion of the agglomerates within the polymer matrix. The premixture can take place at temperatures between approximately 25° C. and 400° C., being preferable a temperature between approximately 100° C. and 250° C., being even more preferable a temperature between approximately 100° C. and 190° C.

The melt mixing/extrusion stage of the present invention takes place in a mixer/extruder assisted by ultrasonic waves with variable frequency and amplitude using continuous or discrete scans or in any other equipment where the melt mixing/extrusion process can take place assisted by ultrasonic waves with variable frequency and amplitude, a process that enables the breakup of agglomerates and the homogeneous dispersion of nanoparticles within the polymer matrix using continuous or discrete scans.

The mixture/extrusion process assisted by ultrasonic waves with variable frequency and amplitude used in the present invention can take place at temperatures between 25° C. and 400° C., being preferable a temperature between 100° C. and 250° C., being even more preferable a temperature between approximately 100° C. and 190° C. for the polymers used in this invention. For the purposes of the present invention, ultrasound and/or ultrasonic waves will be understood as high-energy acoustic waves. Discrete frequency scans refers to the operating conditions in which a specific operating frequency is used during a lengthy time interval, before moving onto the next operating frequency, which is dictated by a smaller ramp greater or equal to 0.01 KHz. Continuous frequency scan refers to the operating conditions in which a specific operating frequency is used during a short time interval, before moving onto the next operating frequency, which is dictated by a smaller ramp greater or equal to 0.01 KHz.

The ultrasonic wave frequency applied in the present invention can preferably have values between 15 kHz and 50 kHz, with continuous scan speeds between 2.5 kHz/s and 10 kHz/s, and between 1.7×10⁻³ and 5×10⁻² kHz/s for discrete scans; more preferably, the ultrasonic wave frequency applied can fall between 30 kHz and 50 kHz.

The ultrasonic waves with variable frequency and amplitude used in the present invention are applied in the mixing/extrusion process once the molten material travels through the pressurized zone, that is to say, in the instant in which the molten material experiences a depressurization in a depressurized zone.

As a preferred second variable to the mixing/extrusion process assisted by ultrasonic waves of variable frequency and amplitude described in this invention, the ultrasonic waves, produced by a frequency wave generator, can be applied in more than one zone during the mixing/extrusion process, as long as they are applied over the depressurized zone of the molten material.

### EXAMPLES

The method for obtaining the nanocomposites will be illustrated more clearly through the following examples, which are included here only for illustrative purposes without limiting the present invention.

### Example 1

### Commodity Polymers—Carbon Nanoparticles: Nanocomposites of i-PP-MWNT

Case 1. Discrete frequency scans.

1.1 Materials and experimental procedure

The preparation of i-PP/MWNT nanocomposites was carried out using the process described in this invention, which consists of a premixing process and the subsequent homogeneous dispersion of the nanoparticles in the polymeric matrix using a mixing/extrusion process assisted by ultrasonic waves of variable frequency and amplitude.

In the premixing stage of the process i-PP with an average molecular weight of 220,000 g/mol and a flow index of 35 g/10 min was used, as well as MWNT with an average diameter between 50 nm and 80 nm and a length distribution from 1 μm to 50 μm. The MWNT weight percentages used were 31%, 35%, 40%, and 60%. Samples weighting 100 g were prepared and introduced into a Brabender® Plasti-Corder PL-2000 internal mixer, where the premixing was carried out using operating temperatures of 180-190° C., 180-190° C., 180° C., and 180° C., respectively. The premixed material was cooled to room temperature and subsequently ground until particle sizes of less than 2 mm were obtained. Subsequently, the mixed material was introduced into a Dynisco LME-120 mixer/extruder operated at a temperature between 190° C. and 200° C., except for the mixture containing 60% by weight, which was prepared in a Dynisco LMM-120 mixer/extruder. The molten material was subjected to ultrasonic waves with a variable frequency and amplitude interval of 30 kHz to 40 kHz. The discrete scan speed of the frequency waves was 1.7×10⁻³ kHz/s with intervals of 100 Hz. The ultrasonicated nanocomposite obtained from the mixer/extruder was cooled and subsequently pelletized.

1.2 Volumetric resistivity

The values of the volumetric resistivity (ρ) of the processed nanocomposites were obtained indirectly through the Kelvin test method or four-point probe method, described in detail in the literature, using nanocomposite samples in pellet form with a diameter of 8 mm and a thickness of 1.5 mm. The pellets were prepared by melting the nanocomposite at 190° C. using a heating rate of 10° C./min, holding this temperature for 3 min, and subsequently cooling to room temperature at a cooling rate of 10° C./min, by means of a Mettler Toledo FP90 Central Processor and a Mettler Toledo FP82HT hot stage. Table 1 shows the electrical conductivity data of the resulting nanocomposites as a function of MWNT concentration.

1.3 Physical properties

Measurements of the initial (Tₒ) and peak (T_{c}) crystallization temperatures of the nanocomposites were made using a TA instruments 2920 modulated differential scanning calorimeter (DSC). These measurements were made on the disc-shaped samples previously prepared and employed a heating/cooling/heating process from a temperature of 0° C. to 200° C., at heating and cooling rates of 10° C./min, and in a N₂ atmosphere. Table 1 shows the resulting Tₒ and T_{c}. The degradation temperature (T_{d}) of the nanocomposites was determined using a TA instruments Q500 thermogravimetric analyzer (TGA). These measurements were made on the disc-shaped samples previously described using a heating rate of 10° C./min and a nitrogen atmosphere from a temperature of 25° C. to 600° C. and a heating rate of 20° C./min in an oxygen atmosphere from a temperature of 600° C. to 800° C. Table 1 shows the obtained T_{d}.

Case 2. Continuous frequency scan: Materials and experimental procedure

This nanocomposite was prepared using the same procedure as described for example 1. Nanocomposites containing i-PP were prepared having flow indexes of 35 g/10 min (i-PP35), 55 g/10 min (i-PP55) and mixtures of these (i-PP35/55), using MWNT with diameters of 15-45 nm, 20-30 nm, 30-50 nm and 50-80 nm, with a weight percentage of 20%, using a continuous scan speed 5 of kHz/s, for frequency intervals of 15-30 kHz (F1), 30-40 kHz (F2), and 40-50 kHz (F3).

In addition, for comparison purposes, nanocomposite samples of i-PP/MWNT (i-PP/MWNT-S) were prepared using a solution process described in Mexican patent application NL/E/2005/000962, using a fixed frequency of 20 kHz and a frequency scan speed of 0 kHz.

2.1 Volumetric resistivity

Measurements of ρ were carried out using the same procedure as described in example 1. Table 2 shows the values of the resistivities obtained.

2.2 Physical properties

Measurements of the nanocomposites' Tₒ and T_{c} were made using the same procedure as described in case 1 of example 1. Table 2 shows the values obtained for Tₒ and T_{c}.

Similarly, the degradation temperature (T_{d}) was determined using the same procedure as described in example 1. Table 2 shows the T_{d} obtained.

### Example 2

### Engineering Polymer-Carbon Nanoparticle: Nanocomposites of Nylon 6-MWNT

3.1. Materials and experimental procedure for discrete frequency scans

This nanocomposite was prepared using the same procedure described in example 1 and an Ultramid® nylon 6 from BASF with a molecular weight of 60,000 g/mol. Nanocomposites were prepared using 0% and 10% by weight of MWNT. An operating temperature of 250° C. was used in the premixing stage, while an operating temperature of 225° C. was used in the mixing/extrusion stage.

3.2. Volumetric resistivity

Measurements of ρ for the nanocomposites were made using the same procedure described in example 1, with one variant: the temperature used to prepare the disc was 250° C. Table 1 shows the resistivity values obtained.

3.3. Physical properties

Measurements of the Tₒ and T_{c} of the nanocomposites were made using the same procedure as described in case 1 of example 1 with one variation: the heating temperature was 260° C. Table 1 shows the values obtained for Tₒ and T_{c}.

Similarly, the degradation temperature (T_{d}) was determined using the same procedure as described in example 1. Table 1 shows the obtained T_{d}.

### Example 3

### Elastomer-Ceramic Nanoparticle: Nanocomposites of EVA-Nanoclay

4.1 Materials and experimental procedure for discrete frequency scans.

This nanocomposite was prepared using the same procedure as presented in example 1. A commercial EVA resin, ELVAX 250®, was used in this instance. Nanocomposites with Cloisite® 6A nanoclay contents of 0% and 5% (EVA/ Cloisite® 6A) were prepared, as well as nanocomposites with Cloisite® 20A nanoclay contents of 0% and 5% (EVA/Cloisite® 20A). In the premixing stage an operating temperature of 90° C. was used, while in the mixing/extrusion stage a temperature of 100° C. was used.

4.2. Physical properties

Measurements of the Tₒ and T_{c} of the nanocomposites were made using the same procedure as described in case 1 of example 1 with a variant in the disc preparation temperature, which was 90° C., and a variant in the heating temperature, which was 140° C. Table 1 shows the values obtained for Tₒ and T_{c}.

Similarly, the degradation temperature (T_{d}) was determined using the same procedure as described in example 1. Table 1 shows the obtained T_{d}.

4.3 Mechanical properties.

Measurements of the storage modulus (E′) were made using a TA Instruments Q800 dynamic mechanical analyzer (DMA). The samples prepared for this measurement had dimensions of 1.52 mm×3.81 mm×1.27 mm. These samples were injected at temperatures of 90° C. to 95° C. with a mold temperature of 80° C. Samples were deformed at temperatures ranging from −30° C. to 80° C. using a heating rate of 2° C./min. Table 1 shows the resulting E′ for the nanocomposites obtained.

4.4 Morphology

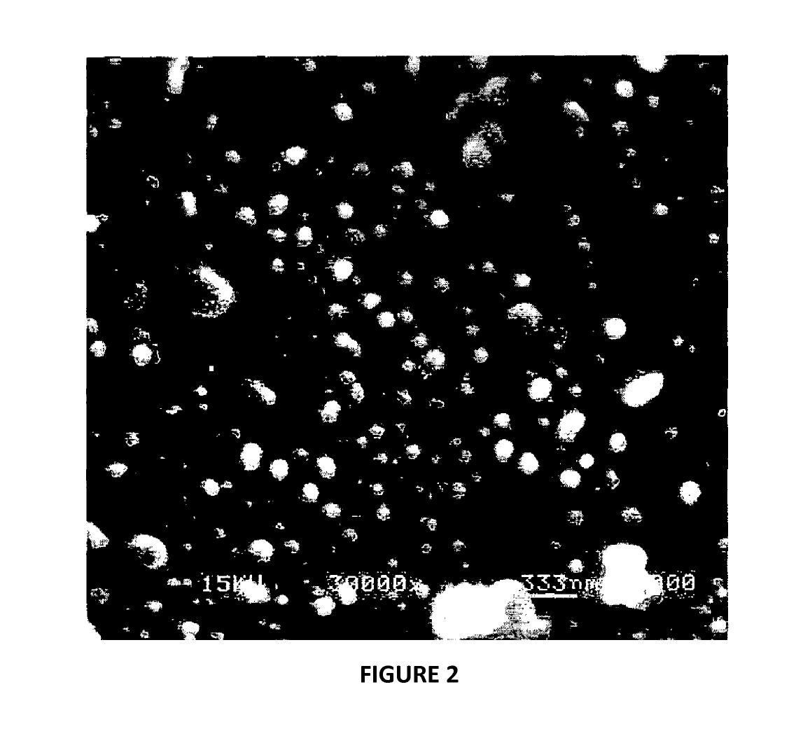

The degree of nanoclay exfoliation within the polymer matrix was determined using X-ray analysis. For this analysis, samples of the obtained nanocomposites were prepared using the same procedure described in the previous section. FIG. 2 shows the X-ray diffractogram of the developed nanocomposites.

### Example 4

### Polymer Mixture-Metallic Nanoparticles: Nanocomposites of LLDPE-α-olefin Copolymers and Silver Nanoparticles (LLDPE-α-olefin/Ag).

5.1 Materials and experimental procedure for discrete frequency scans.

This nanocomposite was prepared using the same procedure as presented in case 1 of example 1. Nanocomposites with silver nanoparticle contents of 0% and 1% were prepared. Both the premixing stage and the mixing/extrusion stage were carried out at 160° C.

5.2. Volumetric resistivity

Measurements of p for the nanocomposites were made using the same procedure described in case 1 of example 1, with one variant: the disc preparation temperature was 160° C. Table 1 shows the resistivity values obtained.

5.3. Physical properties

Measurements of the fusion temperature (T_{f}) and crystallization temperature (T_{c}) of the nanocomposites were made using the same procedure as described for case 1 of example 1, with one variant: the heating temperature was 160° C. Table 1 shows the values obtained for T_{f} and T_{c}.

Similarly, the degradation temperature (T_{d}) was determined using the procedure as described in case 1 of example 1. Table 1 shows the obtained T_{d}.

5.4. Mechanical properties

Measurements of the storage modulus (E′) were made using the procedure described in example 3. In this case, the samples were injected at a temperature of 160° C. with a mold temperature of 130° C. and 150° C., respectively. Samples were subjected to deformation at temperatures ranging from 30° C. to 110° C. using a heating rate of 2° C./min. Table 1 shows the resulting E′ for the nanocomposites obtained.

5.5 Morphology

The degree of dispersion of the silver nanoparticles in the polymer matrix was determined using a TOP GUN CM510 scanning electron microscope (SEM). In this instance samples were made by taking a filament of the ultrasonicated nanocomposite as produced directly by the mixer/extruder and fracturing it under cryogenic conditions. The fractured sample surface was analyzed via SEM at magnifications of 25,000× and 50,000×. FIG. 2 shows an SEM image of the nanocomposite obtained.

The novel aspects of the present invention are described in detail in the attached claims. Nevertheless, the invention itself, its objectives, and its significant advantages are best understood in the following detailed description, when read in the context of the accompanying tables and figures:

TABLE 1

| | Nanoparticles % by | Characterization Parameters | | | | |
|---|---|---|---|---|---|---|
| Nanocomposite | weight | ρ(Ω-cm) | T_{c}(° C.) | T₀(° C.) | T_{d}(° C.) | E′(Mpa) |
| i-PP/NCPM | 31 | 13.4 10⁰ | 118.4 | 121.6 | 459.2 | — |
| | 35 | 5.6 10⁰ | 118.7 | 122.3 | 458.6 | — |
| | 40 | 2.5 10⁰ | 118.7 | 122.4 | 454.4 | — |
| | 60 | 1.4 10⁻¹ | 117.9 | 122.6 | 452.3 | — |
| Nylon/NCPM | 0 | 3.6 10⁷ | 172.8 | 181.0 | 445.6 | 2354 |
| | 10 | 3.5 10⁷ | 200.8 | 214.7 | 454.0 | 2468 |
| EVA/Closite ®6a | 0 | — | 49.4 | 53.9 | 335.6 | 2083 |
| | 5 | — | 51.1 | 55.7 | 458.2 | 2488 |

TABLE 2

| | NCPM | NCPM | | | | |
|---|---|---|---|---|---|---|
| | % by | diameter | Characterization Parameters | | | |
| Nanocomposite | weight | (nm) | T_{c}(° C.) | T₀(° C.) | ρ(Ω-cm) | T_{d}(° C.) |
| i-PP350 | 0 | | 110.0 | 113.9 | — | 447.00 |
| i-PPi55 | 0 | | 126.7 | 130.3 | — | 442.70 |
| i-PP (12 Kg-mol)/ | 20 | 15-45 | 137.3 | 140.0 | 8.8 × 10⁻¹ | 434.10 |
| NCPM | | | | | | |
| i-PP(190 Kg-mol)/ | | | 136.8 | 140.4 | 1.2 × 10⁰ | 449.80 |
| NCPM | | | | | | |
| i-PP(340 Kg-mol)/ | | | 136.1 | 140.4 | 1.5 × 10⁰ | 451.80 |
| NCPM | | | | | | |
| i-PP35/NCPM-F1 | | 20-30 | 117.3 | 120.4 | 3.8 × 10¹ | 455.0 |
| i-PP35/NCPM-F2 | | | 117.7 | 120.6 | 3.8 × 10¹ | 457.1 |
| i-PP35/NCPM-F3 | | | 117.3 | 120.6 | 2.9 × 10¹ | 454.5 |
| i-PP55/NCPM-F1 | | | 133.9 | 136.8 | 1.6 × 10¹ | 451.9 |
| i-PP55/NCPM-F2 | | | 130.7 | 135.1 | 3.6 × 10¹ | 455.0 |
| i-PP55/NCPM-F3 | | | 133.2 | 136.5 | 2.2 × 10¹ | 450.8 |
| i-PP35/55/NCPM-F1 | | | 133.1 | 136.5 | 1.8 × 10¹ | 450.8 |
| i-PP35/55/NCPM-F2 | | | 130.1 | 134.3 | 1.7 × 10¹ | 454.0 |
| i-PP35/55NCPM-F3 | | | 129.6 | 133.5 | 3.0 × 10⁰ | 452.9 |
| i-PP35/NCPM-F1 | | 30-50 | 122.1 | 128.3 | 2.5 × 10¹ | 451.9 |
| i-PP35/NCPM-F2 | | | 118.8 | 129.8 | 5.5 × 10¹ | 455.0 |
| i-PP35/NCPM-F3 | | | 117.2 | 120.8 | 1.8 × 10¹ | 452.4 |
| i-PP55/NCPM-F1 | | | 131.0 | 135.9 | 2.6 × 10¹ | 449.8 |
| i-PP55/NCPM-F2 | | | 134.6 | 138.2 | 1.2 × 10¹ | 456.1 |
| i-PP55/NCPM-F3 | | | 134.2 | 137.4 | 8.9 × 10⁻¹ | 450.8 |
| i-PP35/55/NCPM-F1 | | | 131.5 | 136.3 | 1.7 × 10¹ | 449.8 |
| i-PP35/55/NCPM-F2 | | | 130.0 | 133.7 | 1.5 × 10¹ | 451.9 |
| i-PP35/55NCPM-F3 | | | 130.8 | 134.5 | 1.8 × 10⁰ | 447.7 |
| i-PP35/NCPM-F1 | | 50-80 | 117.7 | 122.6 | 1.5 × 10¹ | 451.8 |
| i-PP35/NCPM-F2 | | | 118.4 | 122.0 | 1.5 × 10¹ | 457.1 |
| i-PP35/NCPM-F3 | | | 117.8 | 121.4 | 1.5 × 10⁰ | 451.9 |
| i-PP55/NCPM-F1 | | | 134.1 | 137.9 | 2.5 × 10¹ | 451.8 |
| i-PP55/NCPM-F2 | | | 134.8 | 138.2 | 9.6 × 10⁰ | 454.0 |
| i-PP55/NCPM-F3 | | | 134.9 | 138.1 | 7.6 × 10¹ | 449.2 |
| i-PP35/55/NCPM-F1 | | | 135.5 | 136.8 | 8.8 × 10¹ | 457.1 |
| i-PP35/55/NCPM-F2 | | | 129.9 | 134.4 | 6.1 × 10⁰ | 458.2 |
| i-PP35/55NCPM-F3 | | | 130.7 | 134.6 | 8.1 × 10¹ | 463.4 |

Table 1 shows the values of the most important characterization parameters that describe the nanocomposites obtained using discrete frequency scans. As an example, it can be observed that the resistivity of the i-PP/MWNT nanocomposites decreases as the MWNT content increases, producing highly conductive nanocomposites at concentrations of up to 60% by weight. The latter represents a very significant technical and economic advantage with respect to existing processes and processes described in the prior art.

Table 2 shows the values of the most important characterization parameters that describe the i-PP/MWNT nanocomposites obtained using continuous frequency scans. A decrease in the electrical resistivity can be observed as the frequency interval of the ultrasonic waves is increased, due to the high degree of dispersion of the MWNT in the i-PP matrix. These values coincide in order of magnitude with those obtained from the nanocomposites prepared from solution, as described in the Mexican patent application NL/E/2005/000962 and attesting to the high degree of dispersion of the MWNT obtained through the process described in this invention.

The examples of the present invention were carried out in a mixing/extrusion equipment that has a pressurized zone containing the premixed material; at the very end of the pressurized zone there is a depressurized zone in which the already molten premixed material comes into contact with ultrasonic waves of variable frequency and amplitude, supplied by a wave generator, that homogeneously disperse the nanoparticles in the polymer matrix. Once the molten material is ultrasonicated, it is subsequently cooled and pelletized.

While the preferred embodiments of the invention have been described above, it will be recognized and understood that various modifications can be made in the invention and the appended claims are intended to cover all such modifications which may fall within the spirit and scope of the invention.

We claim:

1. A continuous melt mixing/extrusion process for the preparation of nanocomposites with a nanoparticle concentration of up to 60% in polymer matrices, comprised by a premixing stage of polymers and/or copolymers or a mixture thereof and at least one nanoparticle, where shear stresses are applied in the molten state and the premixture obtained is subjected to a melt mixing/extrusion stage that is assisted by ultrasonic waves with variable frequency and amplitude and employs continuous and discrete scans, in which the ultrasonic waves originate at a frequency wave generator and can be applied in more than one zone during the mixing/extrusion process, as long as they are applied over at least one depressurized zone of the molten material.

2. A continuous process for the preparation of nanocomposites in accordance to claim 1 wherein the polymer and/or copolymer is selected from the group that comprises commodity polymers, engineering polymers, elastomers, or a mixture of two or more thereof.

3. A continuous process for the preparation of nanocomposites in accordance to claim 2 further characterized by having at least one type of commodity polymer and/or copolymer selected from the group comprised by polyolefins, polyaromatics, poly(vinyl chloride), or a mixture of two or more thereof.

4. A continuous process for the preparation of nanocomposites in accordance with claim 3 further characterized by having at least one type of commodity polymer and/or copolymer selected from the group comprised by polyolefins.

5. A continuous process for the preparation of nanocomposites in accordance with claim 4 further characterized by having at least one type of polyolefin polymer and/or copolymer selected from the group that comprises polyethylenes and polypropylenes.

6. A continuous process for the preparation of nanocomposites in accordance with claim 5 further characterized by having at least one type of polyethylene polymer and/or copolymer selected from the group comprised by LDPE, HDPE, LLDPE, UHMWPE, and EVA, or a mixture of two or more thereof.

7. A continuous process for the preparation of nanocomposites in accordance with claim 6 further characterized by having LLDPE as the selected polymer.

8. A continuous process for the preparation of nanocomposites in accordance with claim 5 further characterized by having at least one type of polypropylene polymer and/or copolymer selected from the group that comprises i-PP, s-PP, a-PP, or a mixture of two or more thereof.

9. A continuous process for the preparation of nanocomposites in accordance with claim 8, further characterized by having i-PP as the selected polymer.

10. A continuous process for the preparation of nanocomposites in accordance with claim 2 further characterized by having at least one type of engineering polymer and/or copolymer selected from the group that comprises polyacrylic polyesters, polycarbonates, and polyamides.

11. A continuous process for the preparation of nanocomposites in accordance with claim 10 further characterized by having at least one type of polyamide polymer and/or copolymer selected from the group that comprises nylon 6; nylon 6,6; nylon 11; nylon 6,10; nylon 6,12; or a mixture of one or more thereof.

12. A continuous process for the preparation of nanocomposites in accordance with claim 11 further characterized by having nylon 6 as the selected polymer.

13. A continuous process for the preparation of nanocomposites in accordance with claim 2 further characterized by having at least one type of elastomer polymer and/or copolymer selected from the group that comprises poly(isoprene butadiene), styrene-butadiene-styrene (SBS), and copolymers of ethyl vinyl acetate (EVA), among others.

14. A continuous process for the preparation of nanocomposites in accordance with claim 13 further characterized by having ethyl vinyl acetate (EVA) copolymer as the selected polymer.

15. A continuous process for the preparation of nanocomposites in accordance with claim 1 further characterized by having nanoparticles selected from the group that comprises metallic, ceramic, and carbon nanoparticles.

16. A continuous process for the preparation of nanocomposites in accordance with claim 15 further characterized by having carbon nanoparticles selected from the group that comprises SWNT, MWNT, CNFs, graphene, or a mixture of two or more thereof.

17. A continuous process for the preparation of nanocomposites in accordance with claim 16 further characterized by having MWNT as the selected nanoparticles.

18. A continuous process for the preparation of nanocomposites in accordance with claim 15 further characterized by having nanoparticles selected from the group that comprises silicate nanoclays, phyllosilicates, aluminosilicates, or mixtures of two or more thereof.

19. A continuous process for the preparation of nanocomposites in accordance with claim 18 further characterized by having aluminosilicate nanoclays selected from the group that comprises montmorillonites, hectorite, or mixtures of two or more thereof.

20. A continuous process for the preparation of nanocomposites in accordance with claim 19 further characterized by having nanoclays selected from the group that comprises montmorillonites.

21. A continuous process for the preparation of nanocomposites in accordance with claim 15 further characterized by having metallic nanoparticles selected from the group that comprises silver, gold, copper, zinc, titanium, and multi-metallic nanoparticles and their compounds or mixtures of two or more thereof.

22. A continuous process for the preparation of nanocomposites in accordance with claim 21 further characterized by having silver nanoparticles as the selected metallic nanoparticles.

23. A continuous process for the preparation of nanocomposites in accordance with claim 1 further characterized by a nanoparticle concentration within the polymer-nanoparticle mixture of between 0.01% and 60% of the total mixture weight.

24. A continuous process for the preparation of nanocomposites in accordance with claim 23 further characterized by a nanoparticle concentration within the polymer-nanoparticle mixture of between 1% and 20% of the total mixture weight.

25. A continuous process for the preparation of nanocomposites in accordance with claim 1 further characterized by an operating temperature during the mixing/extrusion process of between 25° C. and 400° C.

26. A continuous process for the preparation of nanocomposites in accordance with claim 25 further characterized by an operating temperature during the mixing/extrusion process of between 100° C. and 190° C.

27. A continuous process for the preparation of nanocomposites in accordance with claim 1 further characterized by the use of ultrasonic waves with frequencies between 15 kHz to 50 kHz during the mixing/extrusion process.

28. A continuous process for the preparation of nanocomposites in accordance with claim 1 further characterized by the use of ultrasonic waves with frequencies between 30 kHz and 50 kHz during the mixing/extrusion process.

29. A continuous process for the preparation of nanocomposites in accordance with claim 1 further characterized by ultrasonic waves that are applied during the mixing/extrusion process with a continuous scan rate of 2.5 kHz/s to 10 kHz/s.

30. A continuous process for the preparation of nanocomposites in accordance with claim 1 further characterized by ultrasonic waves that are applied during the mixing/extrusion process with a discrete scan rate of 1.7×10⁻³ kHz/s to 5×10⁻² kHz/s.

31. A continuous process for the preparation of nanocomposites in accordance with claim 1 further characterized by ultrasonic waves that are applied in a depressurized zone during the mixing/extrusion process.
